(19) United States
(12) Patent Application Publication
(10) Pub. No.: US 2025/0323258 A1
(43) Pub. Date: Oct. 16, 2025

(54) POSITIVE ELECTRODE ACTIVE MATERIAL FOR A RECHARGEABLE LITHIUM-ION BATTERY

(71) Applicant: Umicore, Brussels (BE)

(72) Inventors: JooEun HYOUNG, Cheonan Chungcheongnam-do (KR); Maxime BLANGERO, Cheonan Chungcheongnam-do (KR); HanSol YONG, Cheonan Chungcheongnam-do (KR); Tijl CRIVITS, Olen (BE)

(21) Appl. No.: 18/873,530

(22) PCT Filed: Jun. 12, 2023
(86) PCT No.: PCT/EP2023/065598

§ 371 Date: Dec. 10, 2024

(30) Foreign Application Priority Data
Jun. 13, 2022 (EP) 22178715.3

(51) Int. Cl. H01M 4/525; C01G 53/42; C01G 53/506

(52) U.S. Cl. CPC H01M 4/525; C01G 53/42; C01G 53/506; C01P 2002/50; C01P 2002/52; C01P 2002/72; C01P 2002/74; C01P 2004/03; C01P 2006/40

(57) ABSTRACT

Positive electrode active material comprising lithium, a metal other than lithium and oxygen, wherein the metal has a composition M, wherein M consists of Ni in a content x, Mn in a content y, Co in a content z, and A in a content a, wherein x, y, z, and a are expressed as molar contents, wherein x+y+z+a=100%, wherein x≥70.0%, wherein 0≤y≤30.0%, wherein 0≤z≤30.0%, wherein 0≤a≤2.0%, wherein an X-Ray diffractogram of the positive electrode active material has a (003) peak located at 2θ=17.0° to 20.0° and (104) peak located at 2θ=43.0° to 46.0°, wherein the ratio (maximum intensity of the (003) peak)/(maximum intensity of the (104) peak) is at least 1.530.

The present invention relates to a positive electrode active material, more in particular a positive electrode active material in which the metal has a high Ni content, typically 70 mol % or higher relative to the total transition metal content.

Such positive electrode active materials are known from KR20210018139 A.

Such positive electrode active materials preferably should have a well ordered crystal structure. However, in practice Ni²⁺ may be present on Li⁺ sites in the crystal lattice, which reduces battery performances, such as high capacity fade during cycling.

It is well known that peak intensity ratio of (003)/(104) peaks in an XRD diffractogram can serve as a reliable indicator for the degree of cation mixing, in other words Ni²⁺ occupancy on Lit sites in the layered oxide.

Such positive electrode active materials can be used as a positive electrode active material for Li-based batteries but can also be considered an intermediate product which can undergo additional processing steps to improve its performance as a positive electrode active material.

The present invention aims to improve positive electrode active materials and therefore provides a positive electrode active material for a lithium rechargeable battery comprising lithium and a metal other than lithium and oxygen, wherein the metal has a composition M, wherein M consists of Ni in a content x, Mn in a content y, Co in a content z, and A in a content a, wherein A is at least one chemical element other than Li, Ni, Mn, Co, and O, wherein x, y, z, and a are expressed as molar contents, wherein x+y+z+a=100 mol %,
wherein x≥70.0 mol %,
wherein 0≤y≤30.0 mol %,
wherein 0≤z≤30.0 mol %,
wherein 0≤a≤5.0 mol %,
wherein an X-Ray diffractogram, obtained from a Cu K-α X-Ray radiation source, of the positive electrode active material has a (003) peak located at 2θ=17.0° to 20.0° and (104) peak located at 2θ=43.0° to 46.0°, wherein the ratio (maximum intensity of the (003) peak)/(maximum intensity of the (104) peak) is at least 1.530.

The advantage is that such positive electrode active materials have a better performance than known positive electrode active material.

Preferably, x, y, z, and a are measured by ICP-OES (Inductively coupled plasma).

Preferably, the positive electrode active material is a powder

In one embodiment, element A is selected from the group consisting of Ag, Al, As, Au, B, Ba, Bi, Ca, Ce, Cd, Cr, Cs, Eu, Fe, Ga, Ge, Hg, Sb, Se, In, Ir, K, La, Mg, Mo, Na, Nb, Nd, Os, P, Pb, Pd, Pr, Pt, Rb, Re, Rh, Ru, S, Sc, Se, Si, Sm, Sr, Ta, Te, Ti, Y, V, W, Zn, and Zr or combinations thereof.

Preferably, element A is selected from the group consisting of Al, As, B, Ba, Ca, Ce, Cd, Cr, Cs, Fe, Ga, Ge, Se, In, Ir, K, Mg, Mo, Na, Nb, Nd, P, Pd, Pt, S, Sc, Se, Si, Sr, Ta, Te, Ti, Y, V, W, Zn, and Zr or combinations thereof.

Even more preferably, element A is selected from the group consisting of AI, B, Ba, Ca, Cr, Fe, Mg, Mo, Nb, S, Si, Sr, Ti, Y, V, W, Zn, and Zr, or combinations thereof.

In a preferred embodiment, the ratio (maximum intensity of the (003) peak)/(maximum intensity of the (104) peak) is at least 1.540 and more preferably at least 1.550.

Hereby the beneficial effect of the present invention is present to an even larger degree.

In a preferred embodiment, the molar ratio: Li/(other metal elements than Li) in the positive electrode active material is at least 0.90 and at most 1.10.

In a preferred embodiment, the positive electrode active material is represented by Formula (1):

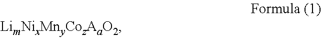

wherein m is at least 0.90 and at most 1.10.

In preferred embodiments:
x>80.0 mol %, preferably x>85.0 mol % and more preferably x>88.0 mol %; and/or
x<98.5 mol % and preferably x<97.0 mol %; and/or
y≤20 mol % and preferably y≤10 mol %; and/or
z≤20 mol % and preferably z≤10 mol %; and/or
(y+z)>1.0 mol % and preferably (y+z)>2.5 mol %; and/or
y>0.5 mol % and z>0.5 mol %.

In a preferred embodiment, the positive electrode active material comprises LiOH in a content of at most 1.40 wt. %, more preferably at most 1.30 wt %, and most preferably at most 1.20 wt % relative to the total weight of positive electrode active material, wherein the content of LiOH is measured by acid-base (pH) titration as described in the description.

LiOH impurity in the positive electrode active material significantly reduces the performance of the final battery, and therefore needs to be reduced as much as possible.

In a preferred embodiment, 0≤a≤2.0 mol %,

Preferably, the positive electrode active material is a powder, in other words a plurality of particles.

More preferably the positive electrode active material is a powder in which a majority of the particles are poly-crystalline particles. Such a powder is otherwise known as a poly-crystalline particle-based powder.

A particle is considered to be poly-crystalline if it consists of 5 or more primary particles, preferably 10 or more primary particles, more preferably 50 or more primary particles as observed in a SEM image. An example of poly-crystalline particles is shown in FIG. 3.

A primary particle can also be called a grain, so that primary particles may be distinguished from each other by observing grain boundaries.

Preferably at least 50%, more preferably at least 80, of the particles in a field of view of at least 45 μm×at least 60 μm (i.e. of at least 2700 μm²), preferably of: at least 100 μm×100 μm (i.e. of at least 10,000 μm²) in a SEM image of said positive electrode active material powder are poly-crystalline.

The invention further concerns a first method for manufacturing the positive electrode active material according to the present invention, comprising the consecutive steps of:
a) heating a precursor material at a heating temperature T1 between 750° C. and 1000° C., preferably between 800° C. and 950° C., and more preferably between 850° C. and 925° C. for a time period t1 between 2 and 20 hours, preferably between 3 and 15 hours, even more preferably between 4 and 10 hours to obtain a heated product,
b) cooling the heated product to a second temperature T2 between 600° C. and 800° C., preferably between 625° C. and 775° C., even more preferably between 650° C. and 750° C., and even more preferably between 675° C. and 725° C. to obtain a second heated product, wherein the average cooling rate is between 10° C./h and 50° C./h, preferably between 20° C./h and 40° C./h, and more preferably between 25° C./h and 35° C./h, to obtain a first cooled product,
c) further cooling the first cooled product to obtain the positive electrode active material.

In a preferred variant of the first method, during step b the heated product is subjected to a temperature which is reduced over the duration of the second heat treatment step at an average rate of at most 45° C./hour, preferably at most 35° C./hour.

In a preferred variant of the first method, during the entire duration of step b the heated product is subjected to a temperature which reduces over time or stays constant over time. Obviously, such a method may be executed in industrial furnaces, in which rapid temperature changes are not possible, so that these terms have to be understood against the background of what is in practice possible in industrial scale furnaces.

In one embodiment, the temperatures of the methods of the present invention are the setting temperature of the furnace.

In a preferred variant of the first method, during at least part of the duration of step b, and preferably during the entire duration of step b, the heated product is subjected to a temperature which is reduced over time at a constant rate

The present invention further concerns a second method for manufacturing a positive electrode active material according to the present invention, comprising the consecutive steps of:
a) heating a precursor material at a heating temperature T1 between 750° C. and 1000° C., preferably between 800° C. and 950° C., and more preferably between 850° C. and 925° C. for a time period t1 between 2 and 20 hours, preferably between 3 and 15 hours, even more preferably between 4 and 10 hours to obtain a heated product,
b) cooling the heated product to a second temperature T2 between 650° C. and 900° C., preferably between 700° C. and 875° C., even more preferably between 750° C. and 850° C., and even more preferably between 775° C. and 825° C. and keeping the temperature T2 for a time t2 between 5 and 20 hours, preferably between 7.5 and 17.5 hours, even more preferably between 10 to 15 hours, to obtain a first cooled product, c) further cooling the first cooled product to obtain the positive electrode active material.

The inventors have found that the cooling profile considerably improves the product properties and results in the positive electrode active materials of the invention.

The cooling profile leads to a positive electrode active material having a reduced LiOH content in accordance with the present invention. Consequently, the positive electrode active material has a better electrochemical performance. Moreover, the positive electrode active material requires less or no after treatment such as washing.

Also, no excess, or a lower excess of lithium source material is required, compared to traditional methods.

Also, the method allows the manufacture of a positive electrode active material, preferably a positive electrode material according to the present invention.

The following preferred variants are applicable to both the first and the second method.

In a preferred variant, x, y, z, and a are measured by ICP-OES (Inductively coupled plasma).

In a preferred variant, ΔT defined as T1-T2 is between 20° C. and 400° C., preferably between 50° C. and 350° C.

In a preferred variant, x≥80.0 mol %, more preferably x≥85.0 mol %, and even more preferably x≥88.0 mol %.

In a preferred variant, x<100.0 mol %., more preferably x<98.5 mol %, and even more preferably x<97.0 mol %.

In a preferred variant, (y+z)>0, more preferably (y+z)>1.5 mol %, and even more preferably (y+z)>3.0 mol %.

In a preferred variant, x<97.0 mol % and y>1.0 mol % and z>1.0 mol %.

In a preferred variant, the positive electrode active material is a powder.

In a preferred variant, a molar ratio: Li/(other metal elements than Li) in the positive electrode active material is at least 0.90 and at most 1.10.

In a preferred variant, the precursor material comprises a source of M and a source of Li, preferably both in an oxidized state.

In a preferred variant, y≤15.0 mol %, and more preferably y≤7.5 mol %.

In a preferred variant, z≤15.0 mol %., and more preferably z≤7.5 mol %.

In a preferred variant of the first method or the second method, the positive electrode active material is a positive electrode active material according to the present invention.

In a preferred embodiment of the positive electrode active material according to the present invention, the positive electrode active material is manufactured by a method according to the present invention.

### BRIEF DESCRIPTION OF THE FIGURES

FIG. 1 shows exemplary temperature profiles of EX1.1 according to the present invention.

FIG. 2 shows exemplary temperature profiles of EX4.2 according to the present invention.

FIG. 3 shows a SEM image of CEX3 having poly-crystalline morphology.

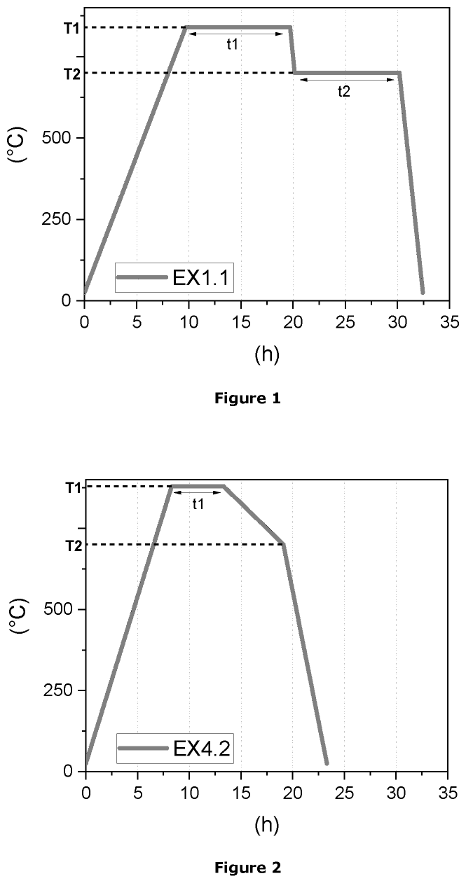

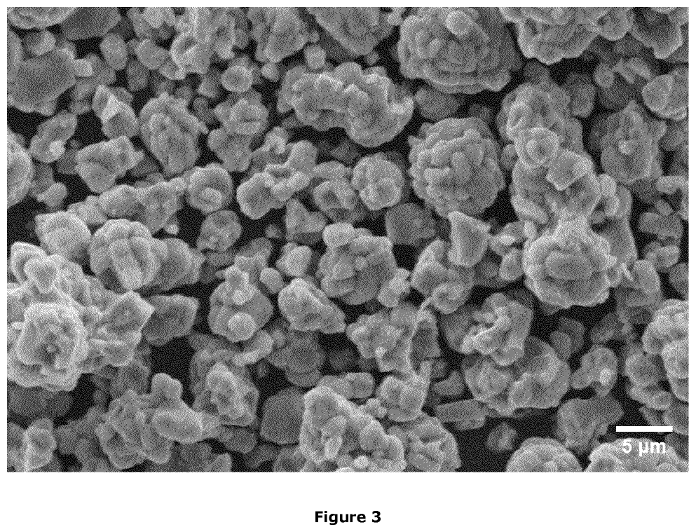

### EXPERIMENTAL TESTS USED IN THE EXAMPLES

The following analysis methods are used in the Examples:

### A) Particle size Distribution (PSD) Analysis

The PSD is measured using a Malvern Mastersizer 3000 with Hydro MV wet dispersion accessory after dispersing examples as described herein below of positive electrode active material powders in an aqueous medium. To improve the dispersion of the positive electrode active material powder examples, sufficient ultrasonic irradiation and stirring is applied, and an appropriate surfactant is introduced. D50 is defined as the particle size at 50% of the cumulative volume % distribution.

### B) Inductively Coupled Plasma—Optical Emission Analysis (ICP-OES) Analysis

The positive electrode active material examples as described herein below are measured by the Inductively Coupled Plasma—Optical Emission Spectrometry (ICP-OES) method using an Agillent ICP 720-OES. 1 gram of a powder sample of each example is dissolved into 50 mL high purity hydrochloric acid in an Erlenmeyer flask. The flask is covered by a watch glass and heated on a hot plate at 380° C. until complete dissolution of the sample. After being cooled to room temperature, the solution and the rinsing water of Erlenmeyer flask are transferred to a 250 mL volumetric flask. Afterwards, the volumetric flask is filled with DI water up to the 250 mL mark, followed by complete homogenization. An appropriate amount of solution is taken out by pipette and transferred into a 250 ml volumetric flask for the 2^{nd} dilution, where the volumetric flask is filled with internal standard and 10% hydrochloric acid up to the 250 mL mark and then homogenized. Finally, this solution is used for ICP-OES measurement. The contents of Ni, Mn, Co, are expressed as mol % of the total of these contents.

### C) Coin Cell Testing

### C1. Coin Cell Preparation

For the preparation of a positive electrode, a slurry that contains a positive electrode active material powder, conductor (Super P, Timcal), binder (KF#9305, Kureha)—with a formulation of 96.5:1.5:2.0 by weight—in a solvent (NMP, Mitsubishi) is prepared by a high-speed homogenizer. The homogenized slurry is spread on one side of an aluminum foil using a doctor blade coater with a 170 μm gap. The slurry coated foil is dried in an oven at 120° C. and then pressed using a calendaring tool. Then it is dried again in a vacuum oven to completely remove the remaining solvent in the electrode film. A coin cell is assembled in an argon-filled glovebox. A separator (Celgard 2320) is located between a positive electrode and a piece of lithium foil used as a negative electrode. 1M LiPF₆ in EC/DMC (1:2) is used as electrolyte and is dropped between separator and electrodes. Then, the coin cell is completely sealed to prevent leakage of the electrolyte.

### C2. Testing Method

The testing method is a conventional “constant cut-off voltage” test. The conventional coin cell test in the present invention follows the schedule shown in Table 1. Each cell is cycled at 25° C. using a Toscat-3100 computer-controlled galvanostatic cycling station (from Toyo). The schedule uses a 1C current definition of 220 mA/g in the 4.3 V to 3.0 V/Li metal window range. The capacity fading rate (QF) is obtained according to below equation.

$$QF ( \% / cycle ) = ( 1 - \frac{{DQ}_{34}}{{DQ}_{7}} ) \times \frac{1}{27} \times 100$$

wherein DQ1 is the discharge capacity at the first cycle, DQ7 is the discharge capacity at the 7th cycle, DQ34 is the discharge capacity at the 34th cycle.

TABLE 1
Cycling schedule for Coin cell testing method

| | Charge | | | | Discharge | | | |
|---|---|---|---|---|---|---|---|---|
| | | | | V/Li | | | | V/Li |
| | | End | Rest | metal | | End | Rest | metal |
| Cycle | C Rate | current | (min) | (V) | C Rate | current | (min) | (V) |
| 1 | 0.1 | — | 30 | 4.3 | 0.1 | — | 30 | 3.0 |
| 2 | 0.25 | 0.05 | 10 | 4.3 | 0.20 | — | 10 | 3.0 |
| 3 | 0.25 | 0.05 | 10 | 4.3 | 0.50 | — | 10 | 3.0 |
| 4 | 0.25 | 0.05 | 10 | 4.3 | 1.00 | — | 10 | 3.0 |
| 5 | 0.25 | 0.05 | 10 | 4.3 | 2.00 | — | 10 | 3.0 |
| 6 | 0.25 | 0.05 | 10 | 4.3 | 3.00 | — | 10 | 3.0 |
| 7 | 0.25 | 0.1 | 10 | 4.3 | 0.10 | — | 10 | 3.0 |
| 8 | 0.25 | 0.1 | 10 | 4.3 | 1.00 | — | 10 | 3.0 |
| 9-33 | 0.50 | 0.1 | 10 | 4.3 | 1.00 | — | 10 | 3.0 |
| 34 | 0.25 | 0.1 | 10 | 4.3 | 0.10 | — | 10 | 3.0 |

### D) Surface Base Analysis

In the measurement of soluble base content by pH titration, two steps are performed: (a) the reparation of solution, and (b) pH titration. The detailed explanation of each step is as follows: Step (a): The preparation of solution: powder is immersed in deionized water and stirred for 10 min in a sealed glass flask containing 100 ml of deionized water. The amount of positive electrode active material powder is 4 grams. After stirring, to dissolve the base, the suspension of powder in water is filtered to get a clear solution.

Step (b): pH titration: 90 ml of the clear solution prepared in step (a) is used for pH titration by using 0.1M HCl. The flow rate is 0.5 ml/min and the pH value is recorded each 3 seconds. The pH titration profile (pH value as a function of added HCl) shows two clear equivalence (or inflection) points. The first equivalence point (corresponding to a HCl quantity of EP1) at around pH 7.4 results from the reaction of OH⁻ and CO₃²⁻ with H⁺. The second equivalence point (corresponding to a HCl quantity of EP2) at around pH 4.7 results from the reaction of HCO3⁻ with H⁺. It is assumed that the dissolved base in deionized water is either LiOH (with a quantity 2*EP1-EP2) or Li₂CO₃ (with a quantity 2*(EP2-EP1)). The obtained values for LiOH and Li₂CO₃ are the result of the reaction of the surface with deionized water.

### E) X-ray Powder Diffraction (XRD)

### E1) XRD Measurement

The X-ray diffraction pattern of the positive electrode active material powder examples as described herein below is collected with a Rigaku X-Ray Diffractometer Ultima 4 using a Cu Kα radiation source (40 kV, 40 mA) emitting at a wavelength of 1.5418 Å. The instrument configuration is set at: a 1° Soller slit (SS), a 10 mm divergent height limiting slit (DHLS), a 1° divergence slit (DS) and a 0.3 mm reception slit (RS). The diameter of the goniometer is 185 mm. For the XRD, diffraction patterns are obtained in the range of 15-50° (2θ) with a scan speed of 3° per min and a step-size of 0.02° per scan.

E2) X-ray diffractogram analysis

The diffractogram obtained from E1) is analyzed in Origin 2018b Version b9.5.5.409 according to below steps:
1. Subtract baseline by End Point Weighted mode and 10% end point
2. Nonlinear curve fit using Voigt line each for peak located at 2θ between 17.0° to 20.0° for (003) peak and 2θ between 43.0° to 46.0° for (104) peak. The Voigt line shape is according to below equation:

$$y = {y}_{0} + A \frac{2 ln 2}{{π}^{\frac{3}{2}}} \frac{{w}_{L}}{{w}_{G}^{2}} {\int }_{- ∞}^{∞} \frac{{e}^{- {𝔱}^{2}}}{{( \sqrt{ln 2} \frac{{w}_{L}}{{w}_{G}} )}^{2} + {( \sqrt{4 ln 2} \frac{x - {x}_{c}}{{w}_{G}} - t )}^{2}} dt$$

3. Identify maximum y value from the obtained fitted curve, each for (003) and (104) peak. Intensity ratio (003)/(104) is obtained by dividing maximum y value of (003) peak to maximum y value of (104) peak.

### F) Scanning Electron Microscope (SEM) Analysis

The morphology of positive electrode active materials may also be performed by a Scanning Electron Microscopy (SEM) with a benchtop device JEOL JCM-6100Plus.

### EXAMPLES

The present invention is further illustrated in the following examples:

### Comparative Example 1

Positive electrode active material CEX1.1 is prepared through a solid-state reaction between a lithium source and a transition metal-based source precursor according to the following steps:
1. Co-precipitation: a transition metal oxidized hydroxide precursor with metal composition of Ni_{0.90}Mn_{0.05}Co_{0.05} is prepared by a co-precipitation process in a large-scale continuous stirred tank reactor (CSTR) with mixed nickel manganese cobalt sulfates, sodium hydroxide, and ammonia.
2. Mixing: precursor prepared from Step 1) is mixed with LiOH and ZrO₂ in an industrial blender to obtain a mixture comprising 0.25 mol % Zr and having a lithium to metal ratio of 1.02.
3. Heating: The mixture from Step 2) is heated under oxygen flow at a first temperature of 700° C. for a first duration of 10 hours and then the temperature is increased to a second temperature of 840° C. for a second duration of 10 hours.
4. Post-treatment: The heated powder from Step 3) is crushed and sieved to obtain a positive electrode active material CEX1.1.

CEX1.2 is prepared according to the same method as CEX1.1, except that the first temperature is 840° C. and the first duration is 10 hours and then the temperature is decreased to the second temperature of 700° C. for a second duration of 2 hours. CEX1.2 is according to the prior art KR20210018139 A.

### Example 1

EX1.1 is prepared according to the same method as CEX1.2, except that the second duration is 10 hours.

EX1.2 is prepared according to the same method as CEX1.2, except that the second duration is 5 hours.

EX1.3 is prepared according to the same method as CEX1.2, except that the first duration is 5 hours and the second duration is 10 hours.

EX1.4 is prepared according to the same method as CEX1.2, except that the first duration is 5 hours and the second duration is 5 hours.

EX1.5 is prepared according to the same method as CEX1.2, except that the second temperature is 660° C. and the second duration is 10 hours.

EX1.6 is prepared according to the same method as CEX1.2, except that the second temperature is 740° C. and the second duration is 10 hours.

EX1.7 is prepared according to the same method as CEX1.2, except that the second temperature is 760° C. and the second duration is 10 hours.

EX1.8 is prepared according to the same method as CEX1.2, except that the second temperature is 660° C. and the second duration is 5 hours.

EX1.9 is prepared according to the same method as CEX1.2, except that the second temperature is 740° C. and the second duration is 5 hours.

EX1.10 is prepared according to the same method as CEX1.2, except that the second temperature is 760° C. and the second duration is 5 hours.

### Comparative Example 2

Positive electrode active material CEX2 is obtained through a solid-state reaction between a lithium source and a transition metal-based source precursor in the following method steps:
1. Co-precipitation: a transition metal-based oxidized hydroxide precursor with metal composition of Ni_{0.92}Mn_{0.03}Co_{0.05} is prepared by a co-precipitation process in a large-scale continuous stirred tank reactor (CSTR) with mixed nickel-manganese-cobalt sulfates, sodium hydroxide, and ammonia.
2. Mixing: the precursor prepared from Step 1) and LiOH as a lithium source are homogenously blended at a lithium to metal M (Li/M) ratio of 0.99 in an industrial blending equipment.
3. Heating: The mixture obtained from step 2) is heated at 820° C. under oxygen flow for 10 hours.
4. Post-treatment: The heated powder from Step 3) is crushed and sieved to obtain CEX2.

### Example 2

EX2 is prepared according to the same method as CEX2, except that Step 3) heating is conducted at a first temperature of 820° C. for a first duration of 10 hours and then the temperature is decreased to a second temperature of 700° C. for a second duration of 5 hours.

### Example 3

Positive electrode active material EX3 is prepared through a solid-state reaction between a lithium source and a transition metal-based source precursor according to the following steps:
1. Co-precipitation: a transition metal oxidized hydroxide precursor with metal composition of Ni_{0.94}Mn_{0.03}Co_{0.03} is prepared by a co-precipitation process in a large-scale continuous stirred tank reactor (CSTR) with mixed nickel manganese cobalt sulfates, sodium hydroxide, and ammonia.
2. Mixing: precursor prepared from Step 1) is mixed with LiOH, ZrO₂, Al₂O₃, in an industrial blender to obtain a mixture comprising 1500 ppm Zr and 700 ppm Al with respect to the total weight of Ni, Mn, and Co and having a lithium to metal ratio of 0.95.
3. Heating: The mixture from Step 2) is heated under oxygen flow at first temperature of 830° C. for 10 hours and then the temperature is decreased to a second temperature of 710° C. for 10 hours.
4. Post-treatment: The heated powder from Step 3) is crushed and sieved to obtain positive electrode active material EX3.

### Example 4

Positive electrode active material EX4.1 is prepared through a solid-state reaction between a lithium source and a transition metal-based source precursor according to the following steps:
1. Co-precipitation: a transition metal oxidized hydroxide precursor with metal composition of Ni_{0.88}Mn_{0.05}Co_{0.07} is prepared by a co-precipitation process in a large-scale continuous stirred tank reactor (CSTR) with mixed nickel manganese cobalt sulfates, sodium hydroxide, and ammonia.
2. Mixing: precursor prepared from Step 1) is mixed with LiOH and ZrO₂ in an industrial blender to obtain a mixture comprising 0.25 mol % Zr with respect to the total molar content of Ni, Mn, and Co and having a lithium to metal ratio of 0.98.
3. Heating: The mixture from Step 2) is heated under oxygen flow at a first temperature of 880° C. for 5 hours and then the temperature is decreased to second temperature of 760° C. for 7.5 hours.
4. Post-treatment: The heated powder from Step 3) is crushed and sieved to obtain positive electrode active material EX4.1.

EX4.2 is prepared according to the same method as EX4.1, except that after the first heating at 880° C., the temperature is slowly decreased to 700° C. with a rate of 30° C./hour and then cooled down to room temperature.

### Comparative Example 3

Positive electrode active material CEX3 is obtained through a solid-state reaction between a lithium source and a transition metal-based source precursor according to the following steps:
1. Co-precipitation: a transition metal oxidized hydroxide precursor with metal composition of Ni_{0.90}Mn_{0.05}Co_{0.05} is prepared by a co-precipitation process in a large-scale continuous stirred tank reactor (CSTR) with mixed nickel manganese cobalt sulfates, sodium hydroxide, and ammonia.
2. First mixing: precursor prepared from Step 1) is mixed with LiOH in an industrial blender to obtain a mixture having a lithium to metal ratio of 1.06.
3. Heating: The first mixture from Step 2) is heated at 890° C. under oxygen flow for 10 h.
4. Post-treatment: The heated powder from Step 3) is crushed and sieved to obtain positive electrode active material CEX3.1.
5. Wet bead milling: CEX3.1 is bead milled in a solution containing 0.5 mol % Co with respect to the total molar contents of Ni, Mn, and Co in the first heated product followed by drying and sieving process to obtain a milled product. The bead milling solid to solution weight ratio was 6:4 and was conducted for 20 minutes.
6. Second mixing: the milled product from Step 4) was mixed with H₃BO₃ as B source and WO₃ as W source to obtain a third mixture comprising 250 ppm of B and 2000 ppm of W.
7. Heat treatment: the second mixture from Step 5) was heated at 350° C. for 7 hours under an oxygen atmosphere to obtain CEX3.2 comprising Ni, Mn, and Co in a ratio Ni:Mn:Co of 0.89:0.05:0.06 as measured by ICP-OES. CEX3.2 has a D50 of 4 μm.

### Example 5

Positive electrode active material EX5 is obtained through a solid-state reaction between a lithium source and a transition metal-based source precursor according to the following steps:
1. Co-precipitation: a transition metal oxidized hydroxide precursor with metal composition of Ni_{0.90}Mn_{0.05}Co_{0.05} is prepared by a co-precipitation process in a large-scale continuous stirred tank reactor (CSTR) with mixed nickel manganese cobalt sulfates, sodium hydroxide, and ammonia.
2. First mixing: precursor prepared from Step 1) is mixed with LiOH and ZrO₂ in an industrial blender to obtain a mixture comprising 0.125 mol % Zr and having a lithium to metal ratio of 1.02.
3. Heating: The first mixture from Step 2) is heated under oxygen flow at a first temperature of 870° C. for 10 hours and then temperature is decreased to a second temperature of 700° C. and kept constant for 10 hours.
4. Post-treatment: The heated powder from Step 3) is crushed and sieved to obtain positive electrode active material EX5.1.
5. Wet bead milling: The heated product from Step 3) is bead milled in a solution containing 0.5 mol % Co with respect to the total molar contents of Ni, Mn, and Co in the first heated product followed by drying and sieving process to obtain a milled product. The bead milling solid to solution weight ratio was 6:4 and was conducted for 20 minutes.
6. Second mixing: the milled product from Step 4) was mixed with H₃BO₃ as B source and WO₃ as W source to obtain a third mixture comprising 125 ppm of B and 1000 ppm of W.
7. Heat treatment: the second mixture from Step 5) was heated at 350° C. for 7 hours under an oxygen atmosphere to obtain EX5.2 comprising Ni, Mn, and Co in a ratio Ni:Mn:Co of 0.89:0.05:0.05 as measured by ICP-OES. EX5.2 has a D50 of 4 μm.

### Results

The results of the experimental tests used on the examples described herein above are as follows:

TABLE 2
Heating conditions and characterization of positive electrode active materials
CEX1.1, CEX1.2, CEX2, EX1.1 to EX1.10, EX2, EX3, EX4.1, and EX4.2

| | First heat | | Second heat | | | | | |
|---|---|---|---|---|---|---|---|---|
| | treatment | | treatment | | ΔT | ICP-OES | Base | XRD |
| | T1 | t1 | T2 | t2 | T1 − T2 | Ni | LiOH | (003)/ |
| ID | (° C.) | (hours) | (° C.) | (hours) | (° C.) | (mol %) | (wt. %) | (104) |
| CEX1.1 | 700 | 10 | 840 | 10 | −140 | 89.5 | 1.49 | 1.528 |
| CEX1.2 | 840 | 10 | 700 | 2 | 140 | 89.8 | 1.43 | 1.549 |
| EX1.1 | 840 | 10 | 700 | 10 | 140 | 89.5 | 0.63 | 1.682 |
| EX1.2 | 840 | 10 | 700 | 5 | 140 | 89.4 | 1.02 | 1.614 |
| EX1.3 | 840 | 5 | 700 | 10 | 140 | 89.4 | 0.47 | 1.643 |
| EX1.4 | 840 | 5 | 700 | 5 | 140 | 89.5 | 0.77 | 1.649 |
| EX1.5 | 840 | 10 | 660 | 10 | 180 | 89.5 | 1.21 | 1.760 |
| EX1.6 | 840 | 10 | 740 | 10 | 100 | 89.5 | 0.51 | 1.576 |
| EX1.7 | 840 | 10 | 760 | 10 | 80 | 89.5 | 0.57 | 1.570 |
| EX1.8 | 840 | 10 | 660 | 5 | 180 | 89.4 | 1.25 | 1.589 |
| EX1.9 | 840 | 10 | 740 | 5 | 100 | 89.4 | 0.85 | 1.595 |
| EX1.10 | 840 | 10 | 760 | 5 | 80 | 89.5 | 0.70 | 1.555 |
| CEX2 | 820 | 10 | n/a | n/a | n/a | 92.2 | 0.63 | 1.491 |
| EX2 | 820 | 10 | 700 | 5 | 120 | 92.2 | 0.54 | 1.568 |
| EX3 | 830 | 10 | 710 | 10 | 120 | 94.0 | 0.21 | 1.559 |
| EX4.1 | 880 | 5 | 760 | 7.5 | 80 | 89.1 | 0.20 | 1.549 |
| EX4.2 | 880 | 5 | 700 | n/a | 180 | 89.1 | 0.20 | 1.560 |
| CEX3.1 | 890 | 10 | n/a | n/a | n/a | 89.3 | 2.23 | 1.528 |
| EX5.1 | 870 | 10 | 700 | 10 | 170 | 89.4 | 0.41 | 1.584 |

n/a = not applicable

TABLE 3
Characterization of positive electrode
active material CEX3 and EX3

| | ICP-OES | Base | | Coin cell |
|---|---|---|---|---|
| | Ni | LiOH | XRD | QF |
| ID | (mol %) | (wt. %) | (003)/(104) | (%/100) |
| CEX3.2 | 89.3 | 0.22 | 1.858 | 24.5 |
| EX5.2 | 89.4 | 0.10 | 1.934 | 14.9 |

Table 2 summarizes the heating conditions, composition, and XRD peak analysis of examples and comparative examples.

CEX1.1 prepared without second heat treatment at a reduced temperature contains higher amount of LiOH in comparison with EX1.1 to EX1.10 which are positive electrode active material containing the same amount of Ni. Moreover, XRD diffractogram analysis showing peak intensity ratio (003)/(104) of EX1.1 to EX1.10 are exceeding 1.53, wherein the maximum intensity of peak (003) is located at 2θ between 17.0° to 20.0° and the maximum intensity of peak (104) is located at 2θ between 43.0° to 46.0°. The intensity ratio of (003)/(104) indicating structure disorder degree wherein lower ratio shows higher structural disorder caused by cation mixing between Li and Ni atoms. Additionally, CEX1.2 prepared with short t2 of 2 hours shows LiOH base of 1.43 wt. % indicating sufficient time at the second temperature is required to mitigate both structural disorder and surface base problems.

EX1.1 to EX1.4 are prepared with variation in t1 and t2 showing that t2 of 10 hours is beneficial to decrease LiOH. On the other hand, a prolonged t2 is linked with a lower furnace throughput. EX1.5 to EX1.10 are positive electrode active material prepared with variation in the second heating in time period of 5 to 10 hours. The comparison showing ΔT in the range of 50 to 300° C. is necessary to decrease LiOH impurities.

CEX2 and EX2 are positive electrode active material containing around 92 mol % Ni prepared without and with application of a second heat treatment at a reduced temperature, respectively. The comparison shows application of second heat treatment at a reduced temperature decreases LiOH base and maintain (003)/(104) XRD peak ratio higher than 1.53.

CEX3.1 and EX5.1 are positive electrode active material containing around 89 mol % Ni prepared without and with application of a second heat treatment at a reduced temperature, respectively. The comparison shows application of second heat treatment at a reduced temperature decreases LiOH base and maintain (003)/(104) XRD peak ratio higher than 1.53.

Table 3 summarizes the heating condition, composition, XRD peak analysis, and electrochemical property of CEX3 and EX5. CEX3 and EX5 are positive electrode active material prepared without and with application of a second heat treatment, respectively. The comparison shows application of second heat treatment decreases LiOH base and maintain (003)/(104) XRD peak ratio higher than 1.88. Moreover, capacity fading QF of EX5 is significantly improved in comparison with CEX3.

1-15. (canceled)

16. A positive electrode active material comprising lithium and a metal other than lithium and oxygen, wherein the metal has a composition M, wherein M consists of Ni in a content x, Mn in a content y, Co in a content z, and A in a content a, wherein A is at least one chemical element other than Li, Ni, Mn, Co, and O, wherein x, y, z, and a are expressed as molar contents, wherein x+y+z+a=100 mol %,
wherein x≥70.0 mol %,
wherein 0≤y≤30.0 mol %,
wherein 0≤z≤30.0 mol %,
wherein 0≤a≤5.0 mol %,
wherein an X-Ray diffractogram, obtained from a Cu K-α X-Ray radiation source, of the positive electrode active material has a (003) peak located at 2θ from 17.0° to 20.0° and a (104) peak located at 20 from 43.0° to 46.0°, wherein a ratio (maximum intensity of the (003) peak)/(maximum intensity of the (104) peak) is at least 1.530,
wherein said positive electrode active material comprises LiOH in a content of at most 1.40 wt. % relative to the total weight of positive electrode active material, wherein the content of LiOH is measured by acid-base titration.

17. The positive electrode active material according to claim 16, wherein the ratio (maximum intensity of the (003) peak)/(maximum intensity of the (104) peak) is at least 1.550.

18. The positive electrode active material according to claim 16, wherein the ratio (maximum intensity of the (003) peak)/(maximum intensity of the (104) peak) is at most 3.000.

19. The positive electrode active material according to claim 16, wherein a molar ratio: Li/(other metal elements than Li) in the positive electrode active material is at least 0.90 and at most 1.10.

20. The positive electrode active material according to claim 16, wherein the positive electrode active material is represented by Formula (1): 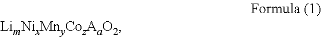
wherein m is at least 0.90 and at most 1.10.

21. The positive electrode active material according to claim 16, wherein x>85.0 mol %.

22. The positive electrode active material according to claim 16, wherein x>88.0 mol %.

23. The positive electrode active material according to claim 16, wherein x<98.5 mol %.

24. The positive electrode active material according to claim 16, wherein (y+z)>1.0 mol %.

25. The positive electrode active material according to claim 16, wherein y>0.5 mol % and wherein z>0.5 mol %.

26. The positive electrode active material according to claim 16, wherein the positive electrode active material comprises LiOH in a content of at most 1.30 wt. % relative to the total weight of positive electrode active material, wherein the content of LiOH is measured by acid-base titration.

27. The positive electrode active material according to claim 16, wherein the positive electrode active material comprises LiOH in a content of at most 1.20 wt. % relative to the total weight of positive electrode active material, wherein the content of LiOH is measured by acid-base titration.

28. The positive electrode active material according to claim 16, wherein the positive electrode active material is poly-crystalline.

29. A method for manufacturing the positive electrode active material according to claim 16, comprising the consecutive steps of:
a) heating a precursor material comprising a source of M and a source of Li at a heating temperature T1 between 750° C. and 1000° C. for a time period t1 between 2 and 20 hours to obtain a heated product,
b) cooling the heated product to a second temperature T2 to obtain a first cooled product,
c) further cooling the first cooled product to obtain the positive electrode active material.
wherein step b is cooling the heated product to a second temperature T2 between 600° C. and 800° C. to obtain a second heated product, wherein the average cooling rate is between 10° C./h and 50° C./h,
or wherein step b is cooling the heated product to a second temperature T2 between 650° C. and 900° C. and keeping the temperature T2 for a time t2 between 5 and 20 hours.

30. The method according to claim 29, wherein ΔT=(T1-T2), wherein 20° C.≤ΔT≤400° C.
